(19) United States
(12) Patent Application Publication
(10) Pub. No.: US 2018/0319694 A1
(43) Pub. Date: Nov. 8, 2018

(54) GLASS MANUFACTURING APPARATUSES WITH COOLING DEVICES AND METHODS OF USING THE SAME

(71) Applicant: Corning Incorporated, Corning, NY (US)

(72) Inventors: Kenneth William Aniolek, Painted Post, NY (US); Robert Delia, Horseheads, NY (US)

(21) Appl. No.: 15/775,957

(22) PCT Filed: Nov. 9, 2016
(86) PCT No.: PCT/US16/61103

§ 371 Date: May 14, 2018

Related U.S. Application Data
(60) Provisional application No. 62/257,517, filed on Nov. 19, 2015.

(51) Int. Cl. C03B 17/06

(52) U.S. Cl. CPC C03B 17/067; C03B 17/064

(57) ABSTRACT

Glass manufacturing apparatuses with cooling devices and methods for using the same are disclosed. In one embodiment, an apparatus for forming a glass web from molten glass includes an enclosure and pulling rolls that cooperate to draw a glass web in a draw direction rotatably positioned in an interior of the enclosure. A cooling device for extracting heat from the glass web is in fluid communication with a cooling fluid source and includes an actively cooled flapper disposed in the interior of the enclosure that is movable to facilitate varying the heat extraction. The actively cooled flapper serves as a heat sink in the interior of the enclosure and the cooling fluid extracts heat from the actively cooled flapper to remove heat from the glass web and the enclosure.

This application claims the benefit of priority under 35 U.S.C. § 119 of U.S. Provisional Application Ser. No. 62/257,517, filed on Nov. 19, 2015, the content of which is relied upon and incorporated herein by reference in its entirety.

### BACKGROUND

### Field

The present specification generally relates to glass manufacturing apparatuses and, more specifically, to fusion draw machines with cooling devices and methods for using the same.

### Technical Background

Glass substrates are commonly utilized in a variety of consumer electronic devices including smart phones, lap-top computers, LCD displays and similar electronic devices. The quality of the glass substrates used in such devices is important for both the functionality and aesthetics of such devices. For example, a lack of surface smoothness on the glass substrates may interfere with the optical properties thereof and, as a result, may degrade the performance of the electronic devices in which the glass substrates are employed. Moreover, variations in the surfaces of the glass substrates that are visually discernible may adversely impact consumer perception of the electronic device in which the glass substrates are employed.

In addition, it is desirable to increase production rates for the manufacture of glass substrates. However, increasing the glass flow rate within glass manufacturing apparatuses also increases heat generation within such apparatuses which, in turn, affects the quality of the glass produced.

Accordingly, a need exists for alternative methods and apparatuses for producing glass substrates.

### SUMMARY

The embodiments disclosed herein relate to fusion draw machines with increased cooling capacities that provide for sufficient cooling of glass web produced with increased flow production rates or decreased glass thickness. Also described herein are glass manufacturing apparatuses that incorporate such fusion draw machines as well as methods for drawing glass webs with increased production flow rates and corresponding increased cooling within the fusion draw machines such that the glass webs are subjected to and experience desired cooling.

According to one embodiment, an apparatus, for example a fusion draw machine, includes an enclosure and a forming vessel comprising outer forming surfaces and a length extending along a long axis of the vessel positioned within the enclosure. The outer forming surfaces converge at a bottom edge, or root, of the forming vessel. A draw plane parallel with the long axis extends in a downstream direction from the root, the draw plane defining a travel path of the glass web from the forming vessel. At least one actively cooled flapper is positioned within the enclosure downstream of the root and extends across the draw plane in a width-wise direction, i.e., parallel with the root. In examples, the apparatus may comprise a pair of actively cooled flappers, the pair of actively cooled flappers arranged in an opposing relationship along opposite sides of the draw plane. The at least one actively cooled flapper comprises a shaft extending parallel to the draw plane and a fin extending outwardly from the shaft, for example extending orthogonally from the shaft. The actively cooled flapper also comprises an axis of rotation parallel with the draw plane such that the actively cooled flapper is rotatable about the axis of rotation. The axis of rotation of the actively cooled flapper may, for example, coincide with an axis of rotation of the shaft. The actively cooled flapper may, in some examples, be rotatable between a horizontal position and a vertical position.

One or more cooling fluid channels of the actively cooled flapper may be in fluid communication with a cooling fluid source, the cooling fluid source supplying a cooling fluid to the one or more cooling channels of the actively cooled flapper. The one or more cooling fluid channels of the actively cooled flapper may comprise an tube-in-tube construction. For example, the cooling fluid channels may be arranged in an annular construction. The cooling fluid supplied by the cooling fluid source may be a mixture of a liquid cooling fluid and a gas cooling fluid. In some examples, the cooling fluid supplied by the cooling fluid source can be water, air or a mixture of water and air.

A first pull roll and a second pull roll can be rotatably positioned within the enclosure. The first pull roll and the second pull roll cooperate to draw the glass web on the draw plane in a downstream direction. The actively cooled flapper may be positioned upstream of the first pull roll and the second pull roll.

The apparatus may further comprise a flapper positioning device mechanically coupled to the actively cooled flapper that locks the actively cooled flapper in a position about its axis of rotation.

In some examples the actively cooled flapper may further comprise a coating disposed thereon such that an emissivity of the coated flapper is in a range from about 0.8 to about 0.95.

In some examples, the enclosure may further comprise a transition upper region, a transition lower region and a liaison region located between the transition upper region and the transition lower region. The actively cooled flapper may be located in a lower portion of the transition upper region, an upper portion of the transition lower region or in the liaison region.

According to another embodiment, a method for forming a glass web includes melting glass batch materials to form molten glass and forming the molten glass into a glass web with a fusion draw machine. The fusion draw machine comprises an enclosure and a forming vessel with outer forming surfaces and a long axis extending in a width-wise direction positioned within the enclosure. The forming surfaces converge at a root. A draw plane parallel with the long axis (i.e., parallel with the root) extends in a downstream direction from the root, the draw plane defining a travel path of the glass web from the forming vessel. At least one actively cooled flapper is included and positioned within the enclosure downstream of the root and extends across the draw plane in the width-wise direction parallel with the draw plane. The actively cooled flapper comprises a shaft arranged parallel with the draw plane and a fin extending outwardly, for example orthogonally, from the shaft.

The glass web is drawn through the enclosure and a cooling fluid is circulated through the actively cooled flapper as the glass web is drawn through the enclosure, the actively cooled flapper extracting heat from the glass web. The cooling fluid may be a mixture of a liquid cooling fluid and a gas cooling fluid. In some examples, the cooling fluid is water, air or a mixture of water and air. The circulating can in some examples comprise circulating the cooling fluid through one or more cooling fluid channels of the actively cooled flapper, the one or more cooling fluid channels comprising a tube-in-tube construction, for example an annular construction.

The method may further comprise orienting the actively cooled flapper relative to the glass web to maximize heat extraction from the glass web. In some examples, the method may comprise orienting the actively cooled flapper at an oblique angle relative to the glass web as the glass web is drawn through the enclosure. In some examples, the actively cooled flapper may be positioned in a horizontal position prior to drawing the glass web through the enclosure.

The method may further comprise rotating the fin about an axis of rotation of the actively cooled flapper and securing the fin in one or more angular positions relative to the glass web, for example between a horizontal position and a vertical position, using a flapper positioning device, the rotating adjusting a heat extraction rate from the glass web as the glass web is drawn through the enclosure.

The method may further comprise contacting the glass web with a pull roll assembly. The pull roll assembly may, for example, be positioned downstream of the actively cooled flapper. The pull roll assembly can be used to draw the glass web from the forming vessel.

In some examples the actively cooled flapper may be coated with a coating such that an emissivity of the coated flapper is in a range from about 0.8 to about 0.95.

Additional features and advantages of the apparatuses and methods described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a glass manufacturing apparatus according to one or more embodiments shown and described herein;

FIG. 2 schematically depicts a partial cross section of the glass manufacturing apparatus of FIG. 1 illustrating a pair of actively cooled flappers within a fusion draw machine;

FIG. 3 is a schematic perspective view of a portion of the glass manufacturing apparatus shown in FIG. 2 downstream of the root;

FIG. 4 schematically depicts an actively cooled flapper according to one or more embodiments shown and described herein;

FIG. 5 schematically depicts an actively cooled flapper according to one or more embodiments shown and described herein;

FIG. 6 schematically depicts an actively cooled flapper according to one or more embodiments shown and described herein;

FIG. 7 schematically depicts an actively cooled flapper according to one or more embodiments shown and described herein;

FIG. 8 schematically depicts an actively cooled flapper according to one or more embodiments shown and described herein;

FIG. 9 schematically depicts a flapper positioning device according to one or more embodiments shown and described herein;

FIG. 10 graphically depicts cooling curves for glass webs produced in a glass manufacturing apparatus according to one or more embodiments shown and described herein; and

FIG. 11 schematically depicts a change in a temperature of a glass web produced in a glass manufacturing apparatus according to one or more embodiments shown and described herein.

### DETAILED DESCRIPTION

Reference will now be made in detail to various embodiments of fusion draw machines with cooling devices and glass manufacturing apparatuses utilizing the same, examples of which are illustrated in the accompanying drawings. Whenever possible, the same reference numerals will be used throughout the drawings to refer to the same or like parts.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation. In particular, unless otherwise indicated, the terms “vertical” and “horizontal” are to be construed relative to the local plane of the earth, where horizontal is parallel with the local plane of the earth, and vertical is perpendicular to the local plane of the earth.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

In one embodiment, an apparatus for forming a glass web is disclosed comprising an enclosure and a forming vessel positioned within the enclosure. The apparatus may comprise, for example, a fusion draw machine (FDM), wherein the forming vessel comprises outer forming surfaces that converge at a bottom edge, or root, of the forming vessel. The forming vessel includes a length extending along a long axis of the forming vessel. A draw plane parallel with the long axis of the forming vessel, i.e. parallel with the root, extends in a downstream direction from the root and generally defines a travel path of a glass web from the forming vessel. The FDM also comprises at least one actively cooled flapper positioned within the enclosure downstream of the root and extending parallel with the draw plane in a width-wise direction. The actively cooled flapper comprises an axis of rotation extending parallel with the draw plane such that the actively cooled flapper is rotatable about the axis of rotation, for example between a horizontal position and a vertical position. The actively cooled flapper also comprises one or more cooling fluid channels in fluid communication with a cooling fluid source. The actively cooled flapper extracts heat from the interior of the enclosure as the glass web travels on the draw plane. Various embodiments of fusion draw machines with cooling devices and methods for using the same will be described in further detail herein with specific reference to the appended drawings.

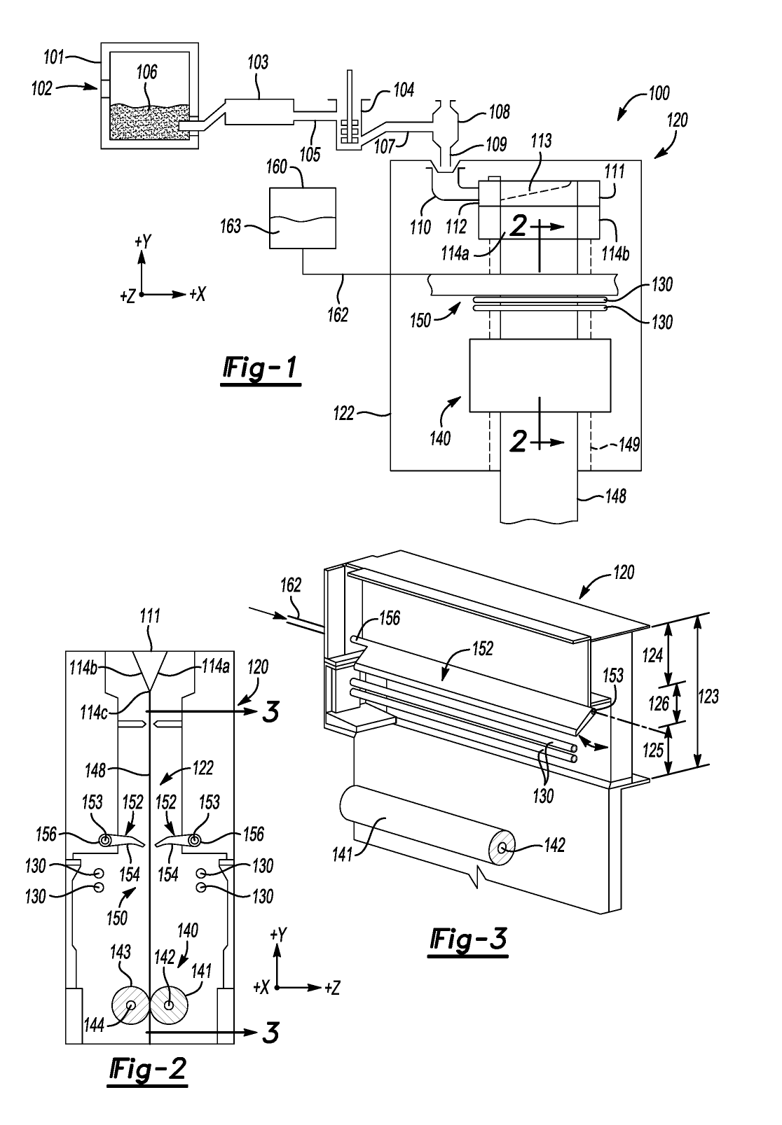

Referring now to FIGS. 1 and 2, one embodiment of an exemplary glass forming apparatus 100 that utilizes an FDM 120 comprising a cooling device 150 is schematically depicted. The glass forming apparatus 100 further includes a melting vessel 101, a fining vessel 103, a mixing vessel 104 and a delivery vessel 108. Glass batch materials are introduced into the melting vessel 101 as indicated by arrow 102. The batch materials are melted to form molten glass 106. The fining vessel 103 includes a high temperature processing region that receives the molten glass 106 from the melting vessel 101 and in which bubbles are removed from the molten glass 106. The fining vessel 103 is in fluid communication with the mixing vessel 104 through a connecting tube 105. That is, molten glass flowing from the fining vessel 103 to the mixing vessel 104 flows through the connecting tube 105. The mixing vessel 104 is, in turn, in fluid communication with the delivery vessel 108 through a connecting tube 107 such that molten glass flowing from the mixing vessel 104 to the delivery vessel 108 flows through the connecting tube 107.

The delivery vessel 108 supplies the molten glass 106 through a downcomer 109 into the FDM 120. The FDM 120 comprises an enclosure 122 in which an inlet 110 and a forming vessel 111 are positioned. As shown in FIG. 1, the molten glass 106 from the downcomer 109 flows into the inlet 110 which leads to the forming vessel 111. The forming vessel 111 includes an opening 112 that receives the molten glass 106. The molten glass 106 flows into a trough 113 of the forming vessel 111 and then overflows and runs down two converging sides 114a and 114b of the forming vessel 111 before fusing together at a root 114c, where the two sides join, thereby forming a glass web 148 that is drawn in the downstream direction (i.e., in the −Y direction of the coordinate axes depicted in FIG. 1) on a draw plane 149 extending in a downstream direction from the root 114c. Accordingly, it should be understood that the draw plane 149 defines a travel path of the glass web 148 from the forming vessel 111, and is parallel with a long axis of the forming vessel (i.e., parallel with the root 114c). In some embodiments, the glass web 148 may be segmented into discrete glass articles or, when the glass web 148 is a thin glass web (i.e., having a thickness equal to or less than about 0.7 mm or even equal to or less than about 0.5 mm), the glass web 148 may be rolled upon itself, for example on a take-up spool. If rolled, an interleaving material may be used between adjacent layers of the glass web if necessary.

Still referring to FIGS. 1 and 2, the glass web 148 may be drawn in the downstream direction by gravity or, alternatively, by a pull roll assembly 140 located downstream from the root 114c. The pull roll assembly 140 includes a first pull roll 141 with an axis of rotation 142 and a second pull roll 143 with an axis of rotation 144 positioned in the enclosure 122. The axes of rotation 142 and 144 are generally parallel to the draw plane 149. The first pull roll 141 and the second pull roll 143 are oriented in parallel with one another such that the first pull roll 141 and the second pull roll 143 cooperate to contact and draw the glass web 148 in a downstream direction. In the embodiments described herein, the first pull roll 141 and the second pull roll 143 may be driven pull rolls, such as when the first pull roll 141 and the second pull roll 143 are actively rotated with a motor to draw the glass web 148. While FIG. 2 depicts a single pair of pull rolls (i.e., the first pull roll 141 and the second pull roll 143), it should be understood that, in other embodiments, the enclosure 122 may further include a plurality of pairs of pull rolls.

Referring now to FIGS. 1-3, a side perspective view of section 3-3 in FIG. 2 illustrates an internal view of the FDM 120 and enclosure 122 positioned therein. The FDM 120 includes a transition region 123 that may be divided into a transition upper region 124 and a transition lower region 125. Located between the transition upper region 124 and the transition lower region 125 is a liaison region 126. The transition upper region 124 is downstream of the forming vessel 111, the liaison region 126 is downstream of the transition upper region 124 and the transition lower region 125 is downstream of the liaison region 126. It should be understood that the transition region 123 is the region where the glass web 148 is cooled after being formed at the root 114c as it travels downstream towards the pull roll assembly 140, which is located downstream of the transition region 123.

Conventionally, the FDM 120 may further include one or more cooling bayonets 130 that assist in cooling the glass web 148 as the web is drawn on the draw plane 149. The cooling bayonets 130 can be present in the transition upper region 124 and/or the transition lower region 125. The cooling bayonets 130 may be slidably positioned within FDM 120 (e.g., within enclosure 122) and are generally positioned parallel to and on opposite sides of the draw plane 149. Once inserted in the enclosure, the cooling bayonets 130 are fixed in position relative to the draw plane 149. A cooling fluid, such as a gas (e.g., air), liquid (e.g., water) or a combination thereof, may be circulated through the cooling bayonets 130 to extract heat from the interior of the FDM 120 to cool the glass web 148 traveling on the draw plane at a predetermined rate. The rate of heat extraction may be varied by inserting or removing the cooling bayonets 130 from the FDM or changing the diameter of the cooling bayonets 130.

The throughput of the glass forming apparatus 100 may be increased by increasing the mass flow rate of molten glass into and through the FDM 120. For a constant thickness of the glass web 148, the temperature inside the FDM 120 increases due to the increased mass flow rate. However, it has been determined that cooling bayonets 130 are insufficient to dissipate the heat generated when the mass flow rate of the glass is significantly increased. Under such conditions the glass cooling curve associated with the FDM 120 drifts towards higher temperatures. As used herein, the cooling curve refers to the temperature of the glass web as a function of distance from the root. The foregoing insufficiency means the glass web 148 is not sufficiently cooled as it travels through the FDM 120 due to the build-up of heat within the enclosure 122.

As the cooling curve drifts towards higher temperatures as a result of the heat build-up, undesirable effects can occur. For example, the stability of the glass web 148 may diminish, causing process disruptions such as, for example, uncontrolled separation of the glass web 148 (commonly referred to as a “crack out”) that decreases production efficiencies. Alternatively or in addition, the relatively high temperature of the glass web 148 as it exits the FDM 120 may result in unequal cooling of the glass web 148 at ambient temperatures, leading to unacceptable attributes in the glass web, i.e., defects such as blisters, cracks, seeds, stones and other inclusions in the glass web. Such defects may result in portions of the glass web 148 being discarded as waste glass. Accordingly, it should be understood that insufficient cooling of the glass web 148 within the FDM 120 as the mass flow rate of the glass into the FDM 120 is increased can cause process instabilities and/or defects in the glass web leading to production inefficiencies. The embodiments described herein provide methods and apparatuses for enhancing the cooling of glass webs traveling through an FDM, improving the stability of the glass web and reducing the occurrence of defects.

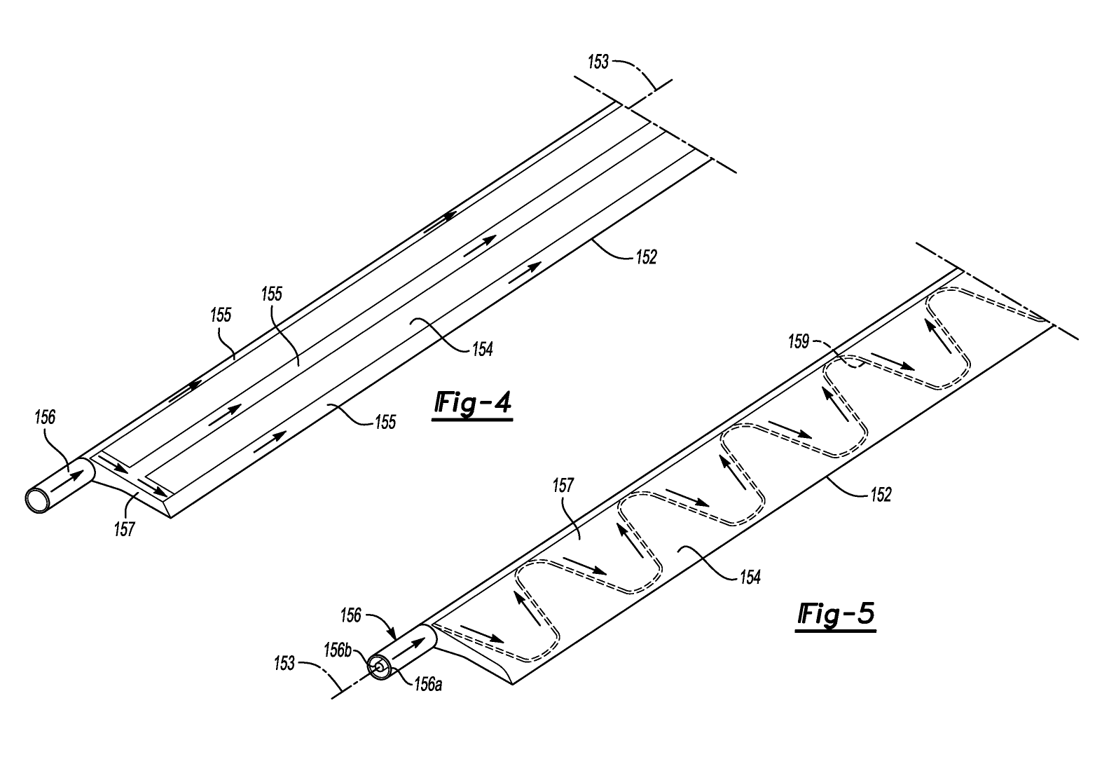

Still referring to FIGS. 1-3, in the embodiments described herein the glass forming apparatus 100 further includes a cooling device 150 in addition to the cooling bayonets 130. The cooling device 150 is located upstream of the pull roll assembly 140 within the enclosure 122 and absorbs heat. That is, the cooling device serves as a heat sink within the enclosure 122. In the embodiments described herein, the cooling device 150 comprises a pair of actively cooled flappers 152 positioned on opposite sides of the draw plane 149 such that the draw plane 149 extends between the pair of actively cooled flappers 152. Each of the actively cooled flappers 152 has an axis of rotation 153 parallel with the draw plane 149, a shaft 156 extending parallel to the axis of rotation 153, and a fin 154 extending from the shaft 156, for example orthogonally, and parallel with the axis of rotation 153. The shaft 156 of each actively cooled flapper 152 is located upstream of the one or more cooling bayonets 130. The shaft 156 can be, for example, a hollow shaft, such as a tube, pipe, or the like, and the fin 154 has one or more cooling fluid channels (depicted in FIGS. 4-5) in fluid communication with the shaft 156. The fin 154 has a length direction extending across the interior of the enclosure 122 in a width-wise direction of the draw plane 149 (i.e., in the +/−X direction of the coordinate axes of FIG. 1) and a width that extends perpendicular to the axis of rotation 153 of the actively cooled flappers 152. That is, the fin includes a length that extends parallel the root 114c and parallel with the draw plane.

The shaft 156 and the fin 154 are rotatable about the axis of rotation 153 such that a position of the fin 154 of the actively cooled flapper 152 is adjustable with respect to the draw plane 149. For example, the fin 154 extending outwardly from the shaft 156 can in some embodiments be oriented substantially perpendicular to the draw plane 149 (and thus perpendicular to a glass web traveling on the draw plane) when the actively cooled flapper 152 is in a horizontal position. The fin 154 can be oriented substantially parallel to the draw plane 149 when the actively cooled flapper 152 is in a vertical position. For the purposes of the instant disclosure, the term “substantially” refers to within +/−five degrees (5°) of a given position. Accordingly, it should be understood that the fin 154 can be oriented at an oblique angle with respect to the draw plane 149 when the actively cooled flapper 152 is not positioned in either a vertical position or a horizontal position. It should be recognized that the fin 154 may be planar, for example comprising at least one planar major surface, for example two oppositely positioned and generally flat (planar) major surfaces, or the fin may be curved and/or include curved major surfaces. Additionally, whether planar or curved, the fin 154 may extend orthogonally from the shaft, or extend tangent to the shaft. In the event the fin 154 comprises at least one generally planar surface, reference to horizontal or vertical orientation is to be construed as the position of the at least one planar surface (the reference plane) relative to a horizontal or vertical plane. In the event the fin 154 is a curved fin, the reference plane of the fin is to be construed as a plane tangent to the fin at the location where the fin joins the shaft 156, recognizing that the fin may be attached orthogonally to the shaft, or tangent to the shaft.

The pair of actively cooled flappers 152 (only one shown in FIG. 3) are located in the transition region 123 downstream of the forming vessel 111 and upstream of the pull roll assembly 140. The actively cooled flapper 152 can be located in a lower portion of the transition upper region 124, an upper portion of the transition lower region 125 or in the liaison region 126. The actively cooled flappers 152 are generally located upstream of the cooling bayonets 130. For example, when one or more cooling bayonets 130 are present in the transition lower region 125 as illustrated in FIG. 3, the shaft 156 of the actively cooled flapper 152 is located upstream of the one or more cooling bayonets 130.

Referring now to FIGS. 1-8, the actively cooled flapper 152 can be cooled, such as by a fluid or the like, to provide increased heat extraction from the glass web 148 and thus increased cooling of the glass web 148 drawn on the draw plane 149. As such, heat is actively removed from the flapper by the circulation of cooling fluid rather than allowing the heat to passively dissipate from the flapper by conduction through the flapper or convection from the flapper. For example, in embodiments, the actively cooled flapper 152 can comprise one or more cooling fluid channels 155 disposed in the fin 154, as depicted in FIG. 4. In this embodiment, the cooling fluid channels are generally oriented parallel to and along a length of the fin 154 of the actively cooled flapper 152. The cooling fluid channels may be positioned on a surface of the fin 154, or within a body of the fin. In some embodiments, the fin 154 may comprise a first major surface part and a second major surface part joined to the first surface part (e.g., with a hollow interior between the first and second surface parts), wherein the cooling fluid channels may be positioned between the first and second surface parts. The cooling fluid channels 155 may be in fluid communication with the shaft 156. A cooling fluid source 160 can be communicatively coupled to the shaft 156 through a cooling fluid line 162 such that the cooling fluid source 160 supplies a cooling fluid 163 to the shaft 156. In these embodiments, cooling fluid 163 is directed into the actively cooled flapper 152 through one end of the shaft 156 (as shown by the arrow proximate the reference numeral 156 in FIG. 4) such as by a pump, gravity feed or the like. In the embodiment depicted in FIG. 4, the cooling fluid 163 flows from the shaft 156 and through the one or more cooling fluid channels 155, and exits the actively cooled flapper 152 at an opposite or distal end (not shown) of the shaft 156. As the cooling fluid is directed through and exits the fin 154 of the actively cooled flapper 152, the cooling fluid extracts heat from the actively cooled flapper 152 and, hence, removes heat from the glass web 148.

In an alternative embodiment, the actively cooled flapper 152 can comprise one or more cooling fluid channels 159 arranged in a serpentine pattern extending along the length of the fin 154, as depicted in FIG. 5. In one embodiment, the cooling fluid 163 may be in fluid communication with the shaft 156, as described herein above with respect to FIG. 4. In an alternative embodiment, the shaft 156 can be in the form of a tube-in-a-tube construction, for example an annular construction, with an outer tube 156a and an inner tube 156b, as depicted in FIG. 5. In this embodiment, the cooling fluid 163 enters the actively cooled flapper 152 through the inner tube 156b, flows through the one or more cooling fluid channels 159, and exits the actively cooled flapper 152 through the passageway or channel between the inner tube 156b and the outer tube 156a. In this manner, the cooling fluid 163 enters and exits the actively cooled flapper 152 at a single end of the shaft 156. Stated differently, the inner tube 156b can be an inlet for the cooling fluid 163 at one end of the shaft 156 and the passageway or channel between the inner tube 156b and the outer tube 156a can be an outlet for the cooling fluid 163 at the same end of the shaft 156. In both embodiments illustrated in FIGS. 4 and 5, the shaft 156 is in fluid communication with the one or more cooling fluid channels 155, 159 through one or openings or apertures (not shown) in the shaft 156 or inner tube 156b. It should be understood that the shaft 156 with a single tube as shown in FIG. 4 can be used with the actively cooled flapper 152 depicted in FIG. 5 and the shaft 156 with the annular construction depicted in FIG. 5 can be used with the actively cooled flapper 152 shown in FIG. 4.

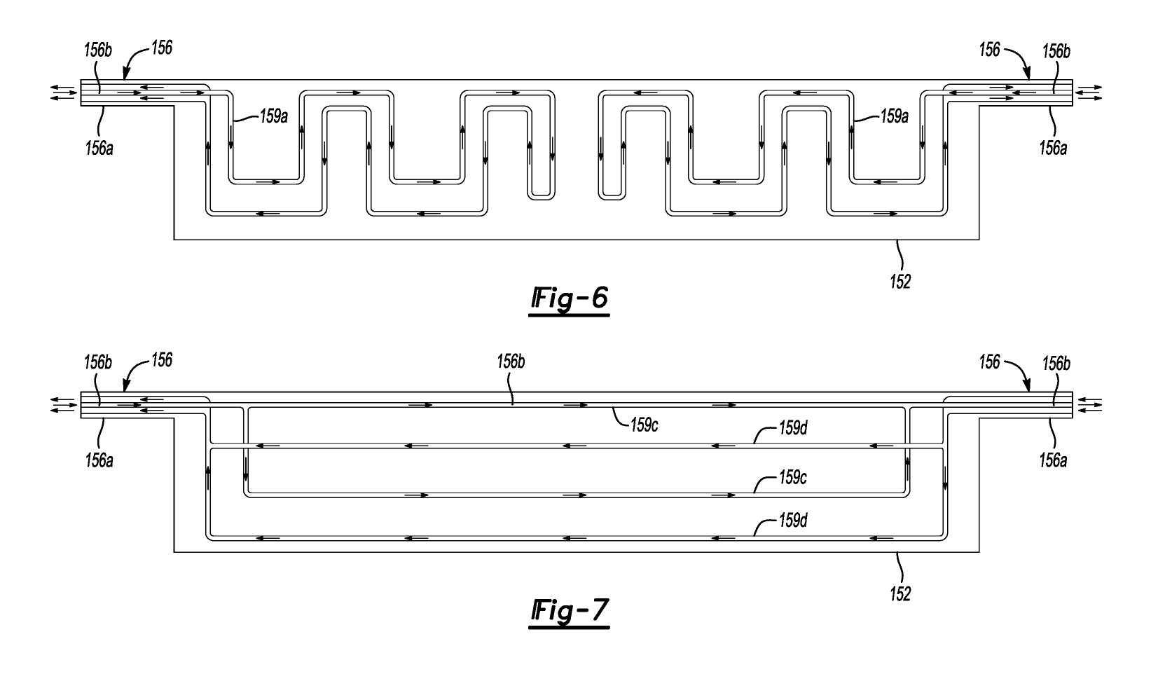

In an alternative embodiment, the actively cooled flapper 152 can comprise a pair of cooling fluid channels 159a arranged in a serpentine pattern extending along the length of the fin 154, as depicted in FIG. 6. One cooling fluid channel 159a may extend from one end of the fin 154 toward the midpoint of the fin 154 and the other cooling fluid channel 159a can extend from the other end of the fin 154 toward the midpoint of the fin 154. In this embodiment, the shaft 156 can be in the form of a tube-in- tube construction with an outer tube 156a and an inner tube 156b, as depicted in FIG. 5. For example, the shaft may be of an annular construction. Accordingly, fluid flowing through one cooling fluid channel is not comingled with fluid flowing through the other cooling fluid channel. In this embodiment, the cooling fluid 163 enters the actively cooled flapper 152 through the inner tube 156b, flows through the one or more cooling fluid channels 159a, and exits the actively cooled flapper 152 through the passageway or channel between the inner tube 156b and the outer tube 156a. In this manner, the cooling fluid 163 enters and exits the actively cooled flapper 152 at a single end of the shaft 156.

In an alternative embodiment, the actively cooled flapper 152 can have one or more cooling fluid channels 159c and one or more cooling fluid channels 159d extending along the length of the fin 154, as depicted in FIG. 7. The shaft 156 can be in the form of a tube-in-a-tube construction with the outer tube 156a and an inner tube 156b, as depicted in FIG. 5. For example, the shaft may be of an annular construction. Accordingly, the cooling fluid 163 enters the actively cooled flapper 152 through the inner tube 156b on the left end of shaft 156, flows through the one or more cooling fluid channels 159c in a left-to-right direction and exits the actively cooled flapper 152 through the inner tube 156b at the right end of the shaft 156. The cooling fluid 163 also enters the actively cooled flapper 152 through the passageway or channel between the inner tube 156b and the outer tube 156a on the right end of the shaft 156, flows through the one or more cooling fluid channels 159d in a right-to-left direction, and exits the actively cooled flapper through the passageway or channel between the inner tube 156b and the outer tube 156a on the left end of the shaft 156. It should be appreciated that the cooling fluid channels 159c and cooling fluid channels 159d are alternately located along the width of the fin 154.

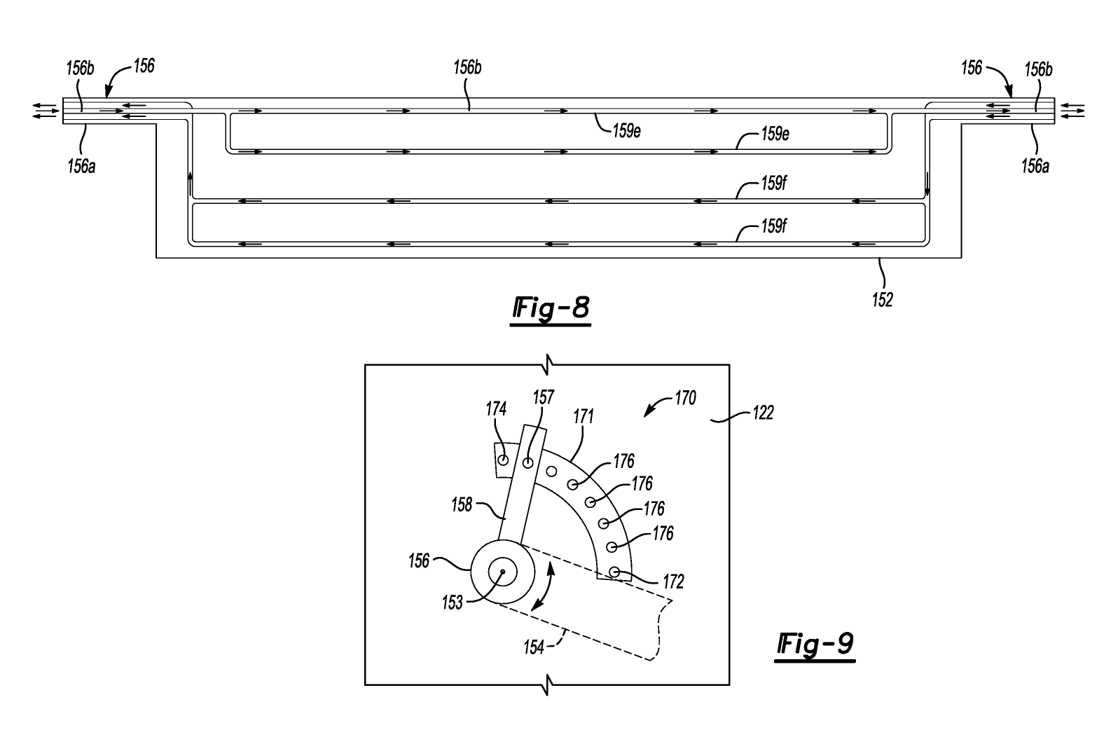

In an alternative embodiment, the actively cooled flapper 152 can comprise one or more cooling fluid channels 159e and one or more cooling fluid channels 159f extending along the length of the fin 154. The shaft 156 can be in the form of a tube-in-a-tube construction with the outer tube 156a and an inner tube 156b, as depicted in FIG. 5. For example, the shaft may be of an annular construction. While viewing FIG. 8, the cooling fluid 163 enters the actively cooled flapper 152 through the inner tube 156b at the left end of shaft 156, flows through the one or more cooling fluid channels 159e in a left-to-right direction and exits the actively cooled flapper 152 through the inner tube 156b at the right end of the shaft 156. The cooling fluid 163 also enters the actively cooled flapper 152 through the passageway or channel between the inner tube 156b and the outer tube 156a at the right end of the shaft 156, flows through the one or more cooling fluid channels 159f in a right-to-left direction, and exits the actively cooled flapper through the passageway or channel between the inner tube 156b and the outer tube 156a on the left end of the shaft 156. It should be appreciated that the cooling fluid channels 159c and cooling fluid channels 159d are located as pairs along the width of the fin 154, as depicted in FIG. 8, i.e. the cooling fluid channels 159c and cooling fluid channels 159d are not alternately located along the width of the fin 154.

The one or more cooling fluid channels 155, 159a, 159c-159f shown in FIGS. 4-8 are for purposes of example only and, as such, it should be understood that any configuration of cooling fluid channels can be used so long as the cooling fluid 163 flows through the fin 154 and thereby extracts heat from the fin 154 and the interior of the enclosure 122.

In the embodiments described herein, the cooling fluid 163 supplied by the cooling fluid source 160 through the cooling fluid line 162 to the one or more cooling fluid channels 155, 159a, 159c-159f of the actively cooled flapper 152 can be a liquid cooling fluid, a gas cooling fluid, or a mixture of a liquid and gas cooling fluid. For example, the cooling fluid can be water, air, or a mixture of water and air. Other gases and liquids having a high heat capacity such as helium and ammonia, and combinations thereof, can be used as the cooling fluid 163.

Referring now to FIGS. 1-2 and 9, the FDM 120 can also include a flapper positioning device 170 that is mechanically coupled to the actively cooled flapper 152. For example, the flapper positioning device 170 can include a shaft bracket 158 rigidly attached to and extending from the shaft 156 and an enclosure bracket 171 rigidly attached to the enclosure 122. The shaft 156 can extend through one side of the enclosure 122 where the flapper positioning device 170 is located with the shaft 156 structurally supported by a wall of the enclosure 122. In the alternative, the shaft 156 can extend through opposite sides of the enclosure 122 and be structurally supported by a pair of walls of the enclosure 122. In one embodiment, the shaft bracket 158 can comprise an aperture 157 and the enclosure bracket 171 can include a series of indexing apertures 172-176 arrayed at regular intervals on an arc. For example, the shaft bracket 158 can be oriented 90 degrees relative to the fin 154 extending from the shaft 156. With such an orientation, the flapper positioning device 170 facilitates locking the actively cooled flapper 152 in the vertical position by aligning the aperture 157 of the shaft bracket 158 with an indexing aperture 172 of the enclosure bracket 171 and inserting a pin (not shown) through the aligned apertures, coupling the shaft bracket 158 to the enclosure bracket 171 and preventing further rotation of the actively cooled flapper 152 about its axis of rotation 153. The actively cooled flapper 152 can be locked in the horizontal position by aligning the aperture 157 of shaft bracket 158 with the indexing aperture 174 of the enclosure bracket 171 and inserting the pin through the aligned apertures. Alternatively, the actively cooled flapper 152 can be locked in one or more intermediate/incremental angular positions, for example between the horizontal position and the vertical position, by aligning the aperture 157 of shaft bracket 158 with one of the indexing apertures 176 of the enclosure bracket 171 and inserting the pin through the aligned apertures. In this manner, the relative alignment of the actively cooled flapper 152 can be controlled relative to the draw plane 149.

Referring again to FIGS. 2, 3 and 9, the axis of rotation 153 of the flapper may be coaxial with the axis of the shaft 156 and rotation of the shaft 156 rotates the fin 154 with respect to the draw plane 149. Accordingly, the exposure angle of the fin 154 can be adjusted and locked in a desired orientation with respect to the draw plane 149 using, for example, the flapper positioning device 170. When the actively cooled flapper 152 is oriented in a substantially vertical orientation such that the surface of the fin 154 is substantially parallel to the draw plane 149 (and hence substantially parallel to a surface of the glass web 148 drawn on the draw plane 149), heat extraction from the glass web 148 is maximized. When the actively cooled flapper 152 is oriented in a substantially horizontal orientation such that the surface of the fin 154 is substantially perpendicular to the draw plane 149 (and hence substantially perpendicular to a surface of the glass web 148 drawn on the draw plane 149), heat extraction from the glass web 148 is minimized. At intermediate orientations of the actively cooled flapper between horizontal and vertical (i.e., when the actively cooled flapper is oriented at an oblique angle with respect to the surface of the glass web 148 drawn on the draw plane 149), heat extraction from the glass web 148 is a fraction of the heat extraction obtained with the actively cooled flapper 152 in the substantially vertical orientation. Accordingly, it should be understood that rotation of the actively cooled flapper 152 with the shaft 156 can be used to adjust the rate of heat extraction from glass web 148 provided by the actively cooled flapper 152 by adjusting the orientation of the fin 154 with respect to the draw plane 149.

In embodiments, the actively cooled flapper 152 can be made from metallic materials suitable for use at high temperatures such as steels, stainless steels, nickel-base alloys, cobalt-base alloys, refractory metals and alloys, and the like. In some embodiments, the shaft 156 of the actively cooled flapper 152 can be made from the same material as the fin 154 while in other embodiments the shaft 156 of the actively cooled flapper 152 can be made from material different than the fin 154.

In embodiments, the actively cooled flapper 152 can have a coating with a relatively high emissivity. In embodiments, the emissivity of the coated flapper may be in a range from about 0.8 to about 0.95. The coating should prevent discoloration of a surface of the actively cooled flapper 152 and thus reduce or prevent hot spots on the fin 154 during production of the glass web 148. In one embodiment, the coating can be a Cetek high emissivity ceramic coating with an emissivity of about 0.92 provided by Cetek Ceramic Technologies located in Brook Park, Ohio, USA. Use of a coating with a relatively high emissivity on the fin 154 provides substantially uniform temperature across the length and width of the actively cooled flapper and aids in uniform heat extraction from the glass web 148.

The FDM 120 with actively cooled flappers 152 described herein may be used in the formation of a glass web 148. For example, during a start-up of the glass forming apparatus 100, the pair of actively cooled flappers 152 can be positioned in the horizontal orientation with no cooling fluid 163 supplied to the one or more cooling fluid channels 155, 159a, 159c-159f to assist in heating the transition upper region 124. Once the glass web 148 has been established and is being pulled downstream with the pull roll assembly 140, cooling fluid 163 can be supplied to the one or more cooling fluid channels 155, 159a, 159c-159f and the position of the actively cooled flapper 152 can be altered to assist in cooling of the glass web 148 as it is pulled through the transition region 123. The angular position of the actively cooled flappers 152 relative to the glass web 148 may be adjusted during start up to obtain a desired cooling of the glass web 148 in the FDM 120. For example, when a greater amount of cooling is desired, the actively cooled flapper 152 may be adjusted towards the vertical position, thereby increasing the exposure of the glass web 148 to the surface of the actively cooled flapper 152 and increasing cooling. When a lesser amount of cooling is desired, the actively cooled flapper 152 may be adjusted towards the horizontal position, thereby decreasing the exposure of the glass web 148 to the surface of the actively cooled flapper 152 and decreasing cooling. The exact position of the actively cooled flappers 152 is dependent, inter alia, on the composition of the glass flowing through the glass forming apparatus 100, the mass flow rate of the glass flowing over the forming surfaces of the forming vessel and the desired cooling curve to be applied to the glass web.

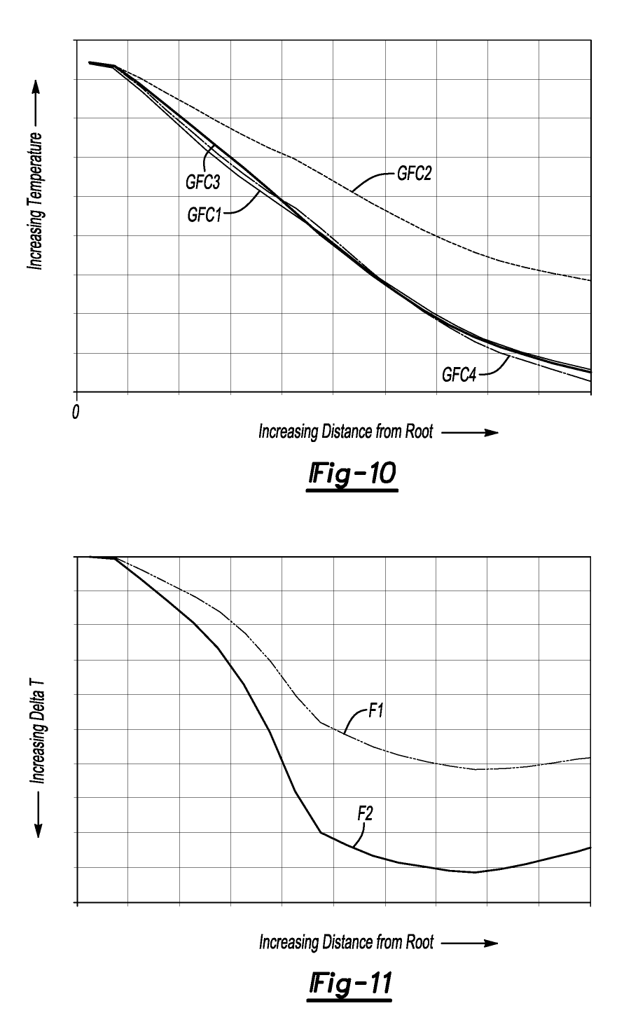

Referring now to FIGS. 1 and 10, FIG. 10 graphically depicts four different exemplary glass web cooling curves obtained by modeling. The cooling curves illustrate the temperature of the glass web 148 as a function of increasing distance from the root 114c of the forming vessel 111 during production of the glass web 148 in an FDM 120 using different glass flow conditions (GFC). The cooling curve labeled GFC1 illustrates a target cooling curve for a glass web 148 produced with a first glass web flow rate and the use of cooling bayonets 130 in the transition region 123. The first glass web flow rate is a standard flow rate and cooling curve GFC1 illustrates a baseline cooling rate for glass web production at the standard flow rate and FDM 120 using only cooling bayonets 130 to extract heat from the enclosure 122. The cooling curve labeled GFC2 is for a second glass web flow rate that is approximately 70% greater than the first glass web flow rate with the same cooling capabilities used for the glass web 148 characterized by curve GFC1 (i.e., an FDM 120 using only cooling bayonets 130 to extract heat from the enclosure 122). As illustrated by curve GFC2, slower cooling of the glass web 148 occurs with the second (and higher) glass web flow rate that can result in both ribbon instability and sub-standard product attributes (i.e., defects). Also, the gap between curve GFC2 and GFC1 indicates the amount of heat extraction needed to produce the glass web 148 at the second glass web flow rate with the target cooling curve GFC1.

In contrast, the cooling curve labeled GFC3 is for the production of a glass web 148 at the second glass web flow rate and with an actively cooled flapper 152 positioned at an angle of 37° relative to horizontal and using water as the cooling fluid 163. The cooling curve labeled GFC4 is for the production of a glass web 148 at a third glass web flow rate that is 40% greater than the first glass web flow rate and cooled using cooling bayonets 130 and with all heating elements (not shown in the figures) in the transition region 123 turned off. It should be appreciated that the cooling curve labeled GFC4 represents the maximum increase in glass web flow rate that can be cooled using conventional FDM cooling practices and still obtain the target cooling curve GFC1.

As illustrated by the cooling curves in FIG. 10, the FDM 120 with the actively cooled flappers 152 disclosed herein provides equivalent cooling for a glass web 148 produced at a 70% greater glass web flow rate as a glass web 148 produced in an FDM 120 cooling with cooling bayonets 130 alone. That is, the use of the actively cooled flappers 152 allows for the target cooling curve GFC1 to be achieved with a 70% increase in mass flow rate of glass. More specifically, the cooling curve GFC3 illustrates a significant increase in the cooling of a glass web 148 in the transition region 123 relative to the use of cooling bayonets 130 alone and relative to the use of cooling bayonets 130 in conjunction with the transition region heating elements turned off, thereby indicating that the throughput of the glass forming apparatus can be increased while mitigating the risk of process instabilities and defects using the actively cooled flappers described herein.

Referring to FIG. 11, a comparison of a glass web cooled using conventional flappers (not cooled) versus actively cooled flappers is shown. The comparison is based on a difference between cooling curves for conventional flappers and actively cooled flappers, and is plotted as the change in temperature (ΔT) between one cooling curve indicative of the use of conventional flappers and another cooling curve indicative of the use of actively cooled flappers. The ΔT between air cooled flappers versus conventional flappers is shown by the curve labeled F1. The ΔT between liquid cooled flappers (e.g., water cooled flappers) versus conventional flappers is shown by the curve F2. The increased cooling (ΔT) provided by air cooled flappers (F1) provides a significant enhancement in cooling capabilities in the transition region compared to conventional flappers while the water cooled flappers provide about a 50% greater cooling enhancement compared to the air cooled flappers.

It should now be understood that fusion draw machines with the cooling devices described herein may be utilized to provide enhanced cooling capabilities during the production of glass web at increased glass flow production rates. The cooling devices described herein may also be used to provide enhanced cooling capabilities during the production of glass web using standard glass flow production rates.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. An apparatus for forming a glass web from molten glass, comprising:
an enclosure;
a forming vessel positioned within the enclosure and comprising outer forming surfaces that converge at a root;
a draw plane extending in a downstream direction from the root, the draw plane parallel with the root; and
at least one actively cooled flapper positioned within the enclosure downstream of the root and extending across the draw plane in a direction parallel with the draw plane, the actively cooled flapper comprising:
a shaft extending parallel with the draw plane and a fin extending outwardly from the shaft;
an axis of rotation extending parallel with the draw plane such that the at least one actively cooled flapper is rotatable about the axis of rotation; and
one or more cooling fluid channels in fluid communication with a cooling fluid source, the cooling fluid source supplying a cooling fluid to the one or more cooling fluid channels of the actively cooled flapper, wherein the actively cooled flapper extracts heat from the glass web as the glass web travels on the draw plane.

2. The apparatus of claim 1, further comprising a first pull roll and a second pull roll rotatably positioned within the enclosure downstream of the actively cooled flapper, wherein the first pull roll and the second pull roll cooperate to draw the glass web on the draw plane in the downstream direction.

3. The apparatus of claim 1, wherein the cooling fluid supplied by the cooling fluid source is a mixture of a liquid cooling fluid and a gas cooling fluid.

4. The apparatus of claim 1, wherein the cooling fluid supplied by the cooling fluid source is water, air or a mixture of water and air.

5. The apparatus of claim 1, further comprising a flapper positioning device mechanically coupled to the actively cooled flapper that locks the actively cooled flapper in a position about the axis of rotation.

6. The apparatus of claim 1, further comprising a coating disposed on the actively cooled flapper such that an emissivity of the coated actively cooled flapper is in a range from about 0.8 to about 0.95.

7. The apparatus of claim 1, wherein the enclosure further comprises a transition upper region, a transition lower region and a liaison region located between the transition upper region and the transition lower region, the actively cooled flapper located in a lower portion of the transition upper region, an upper portion of the transition lower region or in the liaison region.

8. The apparatus of claim 1, wherein the one or more cooling fluid channels of the actively cooled flapper comprises a tube-in-tube construction.

9. A method for forming a glass web, comprising:
melting glass batch materials to form molten glass;
forming the molten glass into the glass web with a fusion draw machine comprising:
an enclosure;
a forming vessel positioned within the enclosure and comprising outer forming surfaces that converge at a root;
a draw plane parallel with the root and extending in a downstream direction from the root, the draw plane defining a travel path of the glass web from the forming vessel; and
at least one actively cooled flapper positioned within the enclosure downstream of the root and extending across the draw plane in a direction parallel with the draw plane, the actively cooled flapper comprising a shaft and a fin extending outwardly from the shaft;
drawing the glass web through the enclosure; and
circulating a cooling fluid through the actively cooled flapper as the glass web is drawn through the enclosure thereby extracting heat from the glass web.

10. The method of claim 9, further comprising orienting the actively cooled flapper relative to the glass web to maximize heat extraction from the glass web.

11. The method of claim 9, further comprising orienting the actively cooled flapper at an oblique angle relative to the glass web as the glass web is drawn through the enclosure.

12. The method of claim 9, wherein prior to drawing the glass web through the enclosure the actively cooled flapper is in a horizontal position.

13. The method of claim 9, wherein drawing the glass web comprises contacting the glass web with a pull roll assembly.

14. The method of claim 13, wherein the pull roll assembly is positioned downstream of the actively cooled flapper.

15. The method of claim 9, further comprising:
adjusting a heat extraction rate from the glass web by the fin as the glass web is drawn through the enclosure by varying an angular position of the fin.

16. The method of claim 9, wherein the cooling fluid is a mixture of a liquid cooling fluid and a gas cooling fluid.

17. The method of claim 9, wherein the cooling fluid is water, air or a mixture of water and air.

18. The method of claim 9, wherein an emissivity of the actively cooled flapper is in a range from about 0.8 to about 0.95.

19. The method of claim 9, wherein the circulating comprises circulating the cooling fluid through one or more cooling fluid channels of the actively cooled flapper, the one or more cooling fluid channels comprising a tube-in-tube construction.

20. The method of claim 19, wherein the tube-in-tube construction is an annular construction.
